(19) United States
(12) Patent Application Publication
(10) Pub. No.: US 2026/0017471 A1
(43) Pub. Date: Jan. 15, 2026

(54) GENERATING MULTILINGUAL VISION LANGUAGE MODELS UTILIZING CONTRASTIVE LANGUAGE IMAGE PRETRAINING

(71) Applicant: Adobe Inc., San Jose, CA (US)

(72) Inventors: Handong Zhao, San Jose, CA (US); Tracy King, Mountain View, CA (US); Kushal Kafle, Boston, MA (US); Rohith Reddy Katikireddy, San Jose, CA (US); Sanat Sharma, Austin, TX (US); Scott Cohen, Sunnyvale, CA (US); Seunghyun Yoon, Seoul (KR); Trung Bui, San Jose, CA (US); Tushar Vatsa, San Francisco, CA (US); Venkata Naveen Kumar Yadav Marri, Newark, CA (US); Wei-ting Hsu, San Jose, CA (US); Hao Tan, San Jose, CA (US); Fangzheng Wu, Sunnyvale, CA (US); Amine Ben Khalifa, Sunnyvale, CA (US); Ajinkya Gorakhnath Kale, San Jose, CA (US)

(21) Appl. No.: 18/771,779

(22) Filed: Jul. 12, 2024

(51) Int. Cl. G06F 40/58; G06V 10/70; G06V 10/74

(52) U.S. Cl. CPC G06F 40/58; G06V 10/761; G06V 10/768

(57) ABSTRACT

The present disclosure relates to systems, non-transitory computer-readable media, and methods for training a multilingual large language model to embed text into an embedding space of a vision language model comprising a text encoder for a first language and a vision encoder. In particular, in some embodiments, the disclosed systems generate, utilizing the vision encoder, image embeddings for images. Additionally, in some embodiments, the disclosed systems generate, utilizing the multilingual large language model, text embeddings for text in languages other than the first language. Furthermore, in some embodiments, the disclosed systems determine similarity metrics between the image embeddings for the images and the text embeddings for the text. Moreover, in some embodiments, the disclosed systems adjust parameters of the multilingual large language model to reduce an output of a contrastive loss function based on the similarity metrics without adjusting parameters of the vision encoder.

### BACKGROUND

Recent years have seen developments in hardware and software platforms implementing vision-language models for various vision-grounded language tasks. For example, existing vision-language systems analyze images to identify objects portrayed in those images, to determine whether the objects relate to a text query, to generate digital images from text prompts, and/or generate descriptions of image content depicted in digital images in response to requests from text prompts. Despite these developments, existing systems suffer from a number of technical deficiencies, including inflexibility, inaccuracy, and inefficiency.

### BRIEF SUMMARY

Embodiments of the present disclosure provide benefits and/or solve one or more problems in the art with systems, non-transitory computer-readable media, and methods for providing multilingual capabilities to a vision language model utilizing contrastive language image pretraining. In particular, in some embodiments, the disclosed systems train a multilingual large language model to embed text into an embedding space of a pretrained vision language model. For example, in some embodiments, the disclosed systems utilize a vision encoder of the vision language model to embed training images and utilize the multilingual large language model to embed training text (e.g., captions, image descriptions, search queries resulting in selections of images, anchor text in image attributes, etc.). In addition, in some embodiments, the disclosed systems utilize a contrastive loss function to adjust parameters of the multilingual large language model while leaving parameters of the vision encoder frozen. Moreover, in some embodiments, the disclosed systems utilize a large training dataset on the order of billions of image-text pairs.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a multilingual vision language system operates in accordance with one or more embodiments.

FIG. 2 illustrates the multilingual vision language system adjusting parameters of a multilingual large language model in accordance with one or more embodiments.

FIG. 3 illustrates the multilingual vision language system adjusting parameters of the multilingual large language model in accordance with one or more embodiments.

FIG. 4 illustrates the multilingual vision language system finetuning the multilingual large language model in accordance with one or more embodiments.

FIG. 5 illustrates the multilingual vision language system processing a query text through a multilingual vision language model to determine corresponding digital images in accordance with one or more embodiments.

FIGS. 6A-6B illustrate results of experiments using the multilingual vision language system in accordance with one or more embodiments.

FIG. 7 illustrates a diagram of an example architecture of the multilingual vision language system in accordance with one or more embodiments.

FIG. 8 illustrates a flowchart of a series of acts for training a multilingual large language model in accordance with one or more embodiments.

FIG. 9 illustrates a block diagram of an example computing device for implementing one or more embodiments of the present disclosure.

### DETAILED DESCRIPTION

This disclosure describes one or more embodiments of a multilingual vision language system with multilingual capabilities that is learned utilizing contrastive language image pretraining. In particular, in some implementations, the multilingual vision language system trains a multilingual large language model to embed text (e.g., captions, image-associated text, such as image descriptions, textual search queries leading to selections of images, and anchor text in image attributes) into an embedding space of a vision language model. For example, the multilingual vision language system utilizes a vision encoder of the vision language model to embed training images. Additionally, the multilingual vision language system utilizes the multilingual large language model to embed training text corresponding to the training images. Moreover, in some implementations, the multilingual vision language system utilizes a contrastive loss function to adjust parameters of the multilingual large language model without adjusting parameters of the vision encoder. Furthermore, in some implementations, the multilingual vision language system utilizes a large training dataset of image-text pairs to train the multilingual large language model (e.g., billions of images and corresponding text across multiple languages).

Additionally, in one or more embodiments, the multilingual vision language system utilizes cross-lingual teacher learning to further assist training the multilingual large language model to embed multi-lingual text into the embedding space of a vision language model. Specifically, in such embodiments, the multilingual vision language system applies teacher learning between the text encoder of the vision language model (the teacher) and the multilingual large language model (the student). Thus, the multilingual vision language system utilizes cross-lingual teacher learning to train the multilingual large language model to generate matching embeddings to that of the text encoder of the vision language model. In one or more implementations, the multilingual vision language system utilizes a mean-squared loss function for the cross-lingual teacher learning. Furthermore, in one or more implementations, the multilingual vision language system utilizes a combined loss (a combination of the contrastive language image pretraining and cross-lingual teacher learning) to update or optimize the parameters of the multilingual large language model to cause the multilingual large language model to accurately embed multilingual text into the embedding space of the vision language model.

Additionally, in one or more implementations, the multilingual vision language system finetunes the multilingual large language model after contrastive pretraining. Specifically, when training data is sparse for one or more languages there is an imbalance among different languages. For example, in some cases, the multilingual vision language system has access to numerous training images and corresponding text in the first language (i.e., the language of the text encoder), many training images and corresponding text in a second language, and relatively few training images and corresponding text in a third language. In some embodiments, the multilingual vision language system utilizes translation-resampling to rectify the sparsity of training data in the third language. For example, the multilingual vision language system translates some of the first-language text into the third language and utilizes the translated text (and their corresponding training images) to augment the training of the multilingual large language model with respect to the third language. By utilizing translation-resampling to finetune the multilingual large language model, the multilingual vision language system improves image-text matching for the augmented language(s). For example, by augmenting the training data for the third language, the multilingual vision language system enhances the accuracy determining matching images for text queries in the third language.

Although existing systems analyze images to identify portrayed objects and determine whether the objects relate to a text query, such systems have a number of problems in relation to flexibility of operation, accuracy, and efficiency. For instance, existing systems often are inflexible in that they are suited to just one language for text queries. In particular, existing systems often perform poorly on second, third, and additional languages, or are outright unable to handle such additional languages for text queries. Additionally, existing systems often suffer from inaccurate image-text matches due to various factors, including inadequate training data and text encoders that are misaligned with vision encoders. Moreover, existing systems utilize excessive computational resources (e.g., memory usage, storage space, bandwidth, computing time, etc.). For example, existing systems sometimes perform machine translation on a query text before analyzing the query text to determine image matches for the query text. Performing machine translation on the query text costs computing time and other computational resources. Furthermore, machine translation of the query text often introduces errors in the semantic meaning of the query text (e.g., particularly for short text strings), thereby leading to inaccuracies in the image-text matches that existing systems produce.

The multilingual vision language system provides a variety of technical advantages relative to existing systems. For example, the multilingual vision language system enhances flexibility of vision language models by providing multilingual capabilities without requiring parallel English text for foreign language text in the training data. For example, by performing large-scale training on image-text pairs across multiple languages, the multilingual vision language system delivers a multilingual vision language model that accurately provides image matches for text queries across multiple languages. For instance, the multilingual vision language system generates a multilingual vision language model that performs image search directly from the language of the text query without first translating the text query. Thus, in addition to providing operational flexibility, the multilingual vision language system enhances computing efficiency by eliminating a common step of machine translation before the image search. Furthermore, the multilingual vision language system enhances both computational efficiency and flexibility by utilizing a single vision encoder to generate image embeddings regardless of language of the corresponding text. Thus, for example, the multilingual vision language system processes a training image once, and the resultant image embedding applies to corresponding text in whichever languages they may be (e.g., English, French, Korean, etc.). By processing each image only once, the multilingual vision language system saves computational resources both in processing and storage and also simplifies use in applications by preventing a need to specify which language a corresponding text caption is in to match the text caption to the image embedding. Moreover, by training the multilingual large language model to embed text into an embedding space of a vision language model without tuning the vision language model, the multilingual vision language system enhances accuracy of text embeddings, thereby also enhancing accuracy of image-text matches.

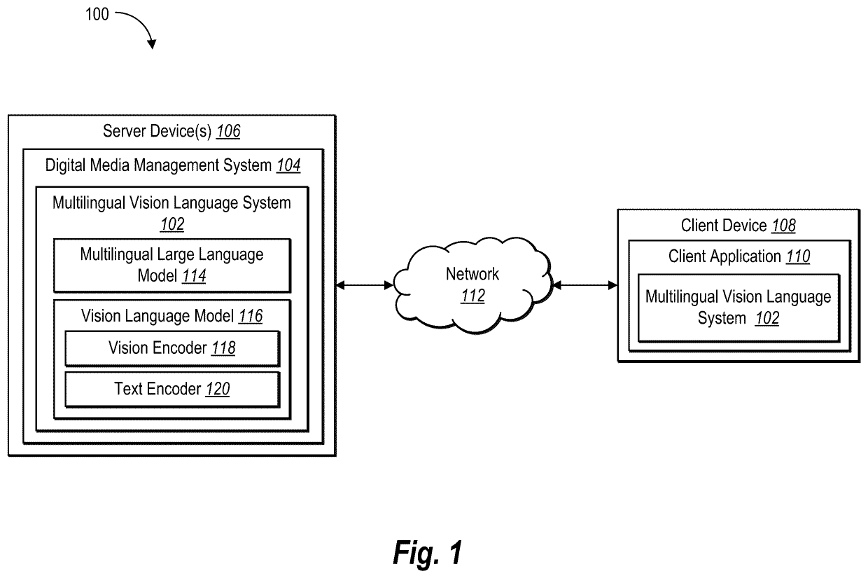

Additional detail will now be provided in relation to illustrative figures portraying example embodiments and implementations of a multilingual vision language system. For example, FIG. 1 illustrates a system 100 (or environment) in which a multilingual vision language system 102 operates in accordance with one or more embodiments. As illustrated, the system 100 includes server device(s) 106, a network 112, and a client device 108. As further illustrated, the server device(s) 106 and the client device 108 communicate with one another via the network 112.

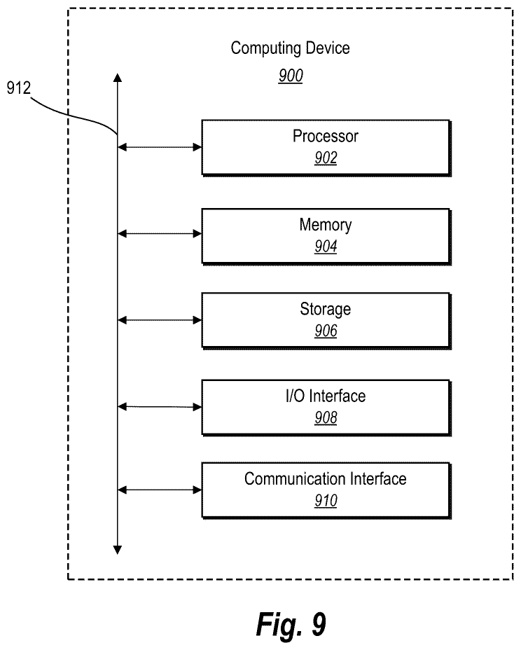

As shown in FIG. 1, the server device(s) 106 includes a digital media management system 104 that further includes the multilingual vision language system 102. In some embodiments, the multilingual vision language system 102 trains a multilingual large language model 114 to embed text into an embedding space of a vision language model 116. In some embodiments, the multilingual vision language system 102 utilizes one or more machine learning models (such as a vision encoder 118 of the vision language model 116) to train the multilingual large language model 114. In some embodiments, the server device(s) 106 includes, but is not limited to, a computing device (such as explained below with reference to FIG. 9).

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

In some embodiments, a vision language model includes or refers to a neural network that processes digital images and/or text prompts to generate text phrases (e.g., text phrases indicating glyphs or words shown in text-rich content of the images). For example, a vision-language model includes or refers to a model based on the architecture described by Simon Jenni et al. in U.S. patent application Ser. No. 18/443,808, titled BUILDING VISION-LANGUAGE MODELS USING MASKED DISTILLATION FROM FOUNDATION MODELS, filed Feb. 16, 2024, which is hereby incorporated by reference in its entirety. In some cases, a vision language model has a particular neural network architecture, including a vision encoder, a text decoder, a projection matrix, and a cross-attention layer.

As mentioned, the multilingual vision language system 102 trains a multilingual large language model 114 to embed text into an embedding space of a vision language model 116. A large language model refers to artificial intelligence models capable of processing and generating natural language text. In particular, language machine learning models are trained on large amounts of data to learn patterns and rules of language. As such, language machine learning model post-training are capable of generating output predictions that indicate visualization structures. Further, in some embodiments, the language machine learning model includes or refers to one or more transformer-based neural networks capable of processing natural language text to generate outputs that range from predictive outputs, analyses, or combinations of data within stored content items (e.g., large language models and language transformer models). In particular, a language machine learning model includes parameters trained (e.g., via deep learning) on large amounts of data to learn patterns and rules of language for summarizing and/or generating digital content. Examples of language machine learning models include BLOOM, Bard AI, ChatGPT, LaMDA, DialoGPT.

In some instances, the multilingual vision language system 102 receives a request (e.g., from the client device 108) to train and/or implement a multilingual large language model. For example, the multilingual vision language system 102 receives batches of digital images and corresponding text to train the multilingual large language model 114. Some embodiments of server device(s) 106 perform a variety of functions via the digital media management system 104 on the server device(s) 106. To illustrate, the server device(s) 106 (through the multilingual vision language system 102 on the digital media management system 104) performs functions such as, but not limited to, determining pairings between images and text, generating image embeddings for the images, generating text embeddings for the text, determining similarity metrics between the image embeddings for the images and the text embeddings for the text, and adjusting parameters of the multilingual large language model based on the similarity metrics. In some embodiments, the server device(s) 106 utilizes the vision encoder 118 of the vision language model 116 and/or a text encoder 120 of the vision language model 116 to train the multilingual large language model 114. In some embodiments, the server device(s) 106 trains the multilingual large language model 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 9. Some embodiments of client device 108 perform a variety of functions via a client application 110 on client device 108. For example, the client device 108 (through the client application 110) performs functions such as, but not limited to, determining pairings between images and text, generating image embeddings for the images, generating text embeddings for the text, determining similarity metrics between the image embeddings for the images and the text embeddings for the text, and adjusting parameters of the multilingual large language model based on the similarity metrics. In some embodiments, the client device 108 utilizes vision encoder 118 of the vision language model 116 and/or the text encoder 120 of the vision language model 116 to train the multilingual large language model 114. In some embodiments, the client device 108 trains the multilingual large language model 114.

To access the functionalities of the multilingual vision language system 102 (as described above and in greater detail below), in one or more embodiments, a user interacts with the client application 110 on the client device 108. For example, the client application 110 includes one or more software applications (e.g., to train and/or implement a multilingual large language model as part of a multilingual vision language model in accordance with one or more embodiments described herein) installed on the client device 108, such as a digital media management application and/or an image access application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the multilingual vision language system 102 is hosted by the client application 110 on the client device 108 (e.g., additionally, or alternatively to being hosted by the digital media management system 104 on the server device(s) 106). For example, the multilingual vision language system 102 performs the multilingual text-image training and implementation techniques described herein on the client device 108. In some implementations, the multilingual vision language system 102 utilizes the server device(s) 106 to train and implement machine learning models (such as the multilingual large language model 114). In one or more embodiments, the multilingual vision language system 102 utilizes the server device(s) 106 to train machine learning models (such as the multilingual large language model 114) and utilizes the client device 108 to implement or apply the machine learning models.

Further, although FIG. 1 illustrates the multilingual vision language system 102 being implemented by a particular component and/or device within the system 100 (e.g., the server device(s) 106 and/or the client device 108), in some embodiments the multilingual vision language system 102 is implemented, in whole or in part, by other computing devices and/or components in the system 100. For instance, in some embodiments, the multilingual vision language system 102 is implemented on another client device. More specifically, in one or more embodiments, the description of (and acts performed by) the multilingual vision language system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106. In response, the multilingual vision language system 102 on the server device(s) 106 performs operations described herein to train and/or implement the multilingual large language model 114. The server device(s) 106 provides the output or results of the operations (e.g., parameters of the multilingual large language model 114 and/or output digital images corresponding to the query text) to the client device 108. As another example, in some implementations, the multilingual vision language system 102 on the client device 108 performs operations described herein to train and/or implement the multilingual large language model 114. The client device 108 provides the output or results of the operations (e.g., parameters of the multilingual large language model 114 and/or output digital images corresponding to the query text) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 9. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

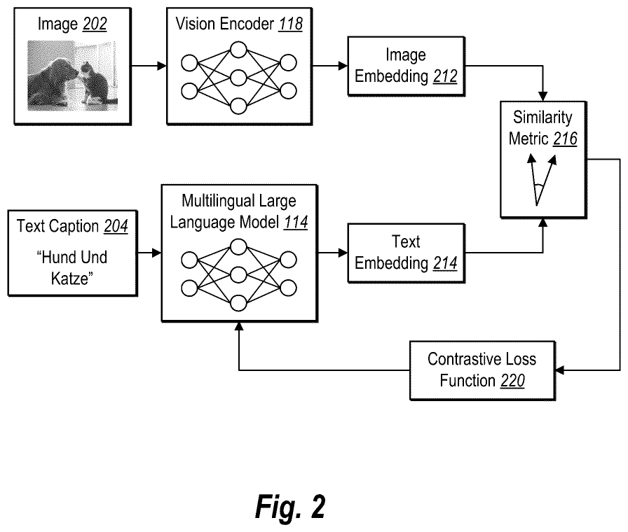

As discussed above, in some embodiments, the multilingual vision language system 102 trains a multilingual large language model to embed text into an embedding space of a vision language model. For instance, FIG. 2 illustrates the multilingual vision language system 102 adjusting parameters of the multilingual large language model 114 in accordance with one or more embodiments.

To illustrate, FIG. 2 shows the multilingual vision language system 102 obtaining a digital image 202 and a text caption 204. For example, the multilingual vision language system 102 obtains a batch of digital images (including the digital image 202) and corresponding text (e.g., the text caption 204). As used herein, training text (or simply text) includes a text string associated with an image, such as an image description, an image caption, a user query that leads to a selection of an image in response to an image search, and/or an anchor text in an image attribute. For instance, the text caption 204 describes one or more features of the image 202, such as one or more objects portrayed in the image 202. Moreover, in some implementations, the text caption 204 is in a language other than the language of the text encoder 120 of the vision language model 116. For example, in some implementations, the text encoder 120 operates on English language text, while the text caption 204 is in another language (e.g., German). Furthermore, in some implementations, the corresponding text to the batch of digital images include text in various languages (e.g., German, French, Korean, Japanese, etc.). For example, some of the text are in German, while others are in Korean. In some implementations, the text include some captions in the same language as the language of the text encoder 120. For example, if the text encoder 120 operates on English language text, some corresponding text for the batch of digital images are in English, while other corresponding text are in other languages. In addition, in some cases, a text caption is in a language that the multilingual large language model 114 is not trained on. Despite some text being in non-target languages, the multilingual vision language system 102 still successfully trains the multilingual large language model 114 for its intended target languages. Thus, the multilingual vision language system 102 provides an additional advantage of not requiring perfect training data. For instance, some text in Portuguese does not prevent the multilingual vision language system 102 from training the multilingual large language model 114 on English, French, and German language tasks.

In some implementations, the multilingual vision language system 102 generates embeddings for the digital images and the corresponding text. To illustrate, the multilingual vision language system 102 utilizes the vision encoder 118 to generate an image embedding 212 for the image 202. Additionally, the multilingual vision language system 102 utilizes the multilingual large language model 114 to generate a text embedding 214 for the text caption 204.

An image embedding includes a numerical representation of features of an image (e.g., features and/or pixels of a digital image). For instance, in some cases, an image embedding includes a vector representation of features of a digital image. To illustrate, an image embedding includes a latent vector representation of a digital image generated by one or more layers of a neural network (e.g., a vision encoder).

A text embedding includes a numerical representation of features of a text string (e.g., features suggesting a semantic connotation or meaning). For example, in some embodiments, a text embedding includes a feature token, feature vector, or other numerical representation of features of a text string, such as a text caption for a digital image. To illustrate, a text embedding includes a vector representation of text generated by processing the text through one or more layers of a neural network (e.g., a large language model).

Moreover, in some embodiments, the multilingual vision language system 102 determines similarity metrics between the image embeddings for the images and the text embeddings for the text. For instance, the multilingual vision language system 102 determines a similarity metric 216 between the image embedding 212 and the text embedding 214. A similarity metric includes a metric that indicates a degree of relatedness between embeddings. For instance, in some embodiments, a similarity metric includes a cosine similarity or a distance metric between an image embedding and a text embedding. To illustrate, the multilingual vision language system 102 determines a cosine similarity that indicates a degree of similarity between the image embedding 212 and the text embedding 214.

As also shown in FIG. 2, in some implementations, the multilingual vision language system 102 utilizes the similarity metric 216 to train the multilingual large language model 114. For example, the multilingual vision language system 102 processes the similarity metric 216 through a contrastive loss function 220. The multilingual vision language system 102 utilizes the outputs of the contrastive loss function 220 to adjust the parameters of the multilingual large language model 114. For example, the multilingual vision language system 102 adjusts the parameters of the multilingual large language model 114 to reduce the output of the contrastive loss function (e.g., for a subsequent training iteration).

A contrastive loss function includes a loss function that learns embeddings such that similar inputs are embedded close together in the embedding space while dissimilar inputs are embedded far apart in the embedding space. For example, a contrastive loss function outputs a low loss value if similar inputs (e.g., a positive pair of a training image with its corresponding text caption) have a small embedding distance, and a high loss value if similar inputs have a large embedding distance. Similarly, a contrastive loss function outputs a low loss value if dissimilar inputs (e.g., a negative pair of a training image and a non-corresponding text caption) have a large embedding distance, and a high loss value if dissimilar inputs have a small embedding distance.

In some implementations, the multilingual vision language system 102 does not adjust the parameters of the vision encoder 118 when training the multilingual large language model 114 to embed text into the embedding space of the language vision model 116. For example, the multilingual vision language system 102 adjusts the parameters of the multilingual large language model 114 without adjusting the parameters of the vision encoder 118. In some cases, by keeping the parameters of the vision encoder 118 fixed, the multilingual vision language system 102 trains the multilingual large language model 114 to embed the text into the embedding space of the vision language model 116. For example, while in some cases the text encoder 120 of the vision language model 116 operates on a first language (e.g., English), the multilingual vision language system 102 trains the multilingual large language model 114 to operate on additional languages (e.g., French, Korean, etc.) by utilizing training text in languages other than the first language.

To further illustrate, in some embodiments, the multilingual vision language system 102 determines parings between images and text, and then determines similarity metrics between image embeddings and text embeddings for the various pairings. For instance, the multilingual vision language system 102 determines a first pairing between a first image and a first text caption (e.g., a text caption that corresponds to the first image). The multilingual vision language system 102 determines a first similarity metric for the first pairing (e.g., by determining a first similarity metric between an image embedding for the first image and a text embedding for the first text caption). Additionally, the multilingual vision language system 102 determines a second pairing between the first image and a second text caption (e.g., a text caption that does not correspond to the first image). The multilingual vision language system 102 determines a second similarity metric for the second pairing (e.g., by determining a second similarity metric between the image embedding for the first image and a text embedding for the second text caption).

Moreover, as mentioned, in some embodiments, the multilingual vision language system 102 adjusts the parameters of the multilingual large language model 114 to increase (e.g., in subsequent training iterations) the first similarity metric and reduce the second similarity metric. Thus, the multilingual vision language system 102 trains the multilingual large language model 114 to generate text embeddings for text that are close (e.g., similar) to their corresponding training images and far (e.g., dissimilar) from noncorresponding training images. Moreover, in some implementations, the multilingual vision language system 102 operates on numerous (e.g., billions of) training images and corresponding text, including text in multiple (e.g., several) languages.

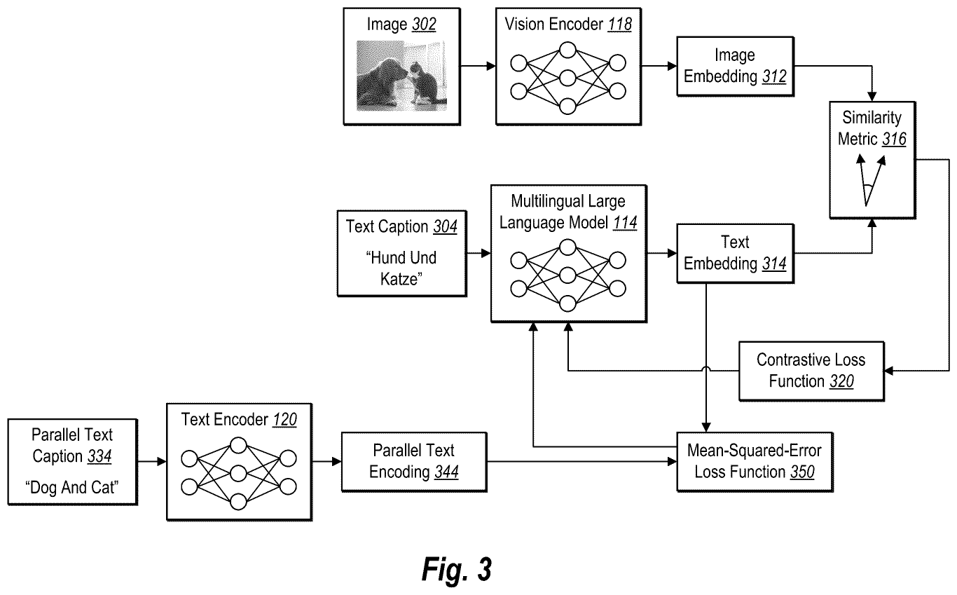

In addition to utilizing contrastive pretraining, in some embodiments, the multilingual vision language system 102 utilizes knowledge distillation to train the multilingual large language model 114. For instance, FIG. 3 illustrates the multilingual vision language system 102 utilizing cross-lingual teacher learning and a contrastive learning in accordance with one or more embodiments to train the multilingual large language model 114.

As just mentioned, FIG. 3 shows the multilingual vision language system 102 training the multilingual large language model 114 utilizing contrastive learning and cross-lingual teacher learning. Similarly to the implementation shown in FIG. 2, in some embodiments, the multilingual vision language system 102 obtains an image 302 and a text caption 304, and generates respective embeddings. For instance, the multilingual vision language system 102 utilizes the vision encoder 118 to generate an image embedding 312, and utilizes the multilingual large language model 114 to generate a text embedding 314. Moreover, in some embodiments, the multilingual vision language system 102 determines a similarity metric 316 between the image embedding 312 and the text embedding 314. The multilingual vision language system 102 processes the similarity metric 316 through a contrastive loss function 320 to tune parameters of the multilingual large language model 114.

In addition to these techniques of contrastive training (as described in greater detail above in connection with FIG. 2), in some implementations, the multilingual vision language system 102 obtains a parallel text caption 334. A parallel text caption includes a text caption that corresponds with another text caption in another language. For example, the parallel text caption 334 is in the first language (i.e., the language of the text encoder 120) while the text caption 304 is in a second language, and shares a common meaning with the parallel text caption 334 (e.g., both the text caption 304 and the parallel text caption 334 describe the same image, but in different languages).

In some embodiments, the multilingual vision language system 102 processes the parallel text caption 334 through the text encoder 120 of the vision language model 116 to generate a parallel text encoding 344. Moreover, in some embodiments, the multilingual vision language system 102 processes the parallel text encoding 344 and the text embedding 314 utilizing a loss function. FIG. 3 illustrates the multilingual vision language system 102 utilizing a mean-squared-error loss function 350. In alternative implementations, the multilingual vision language system 102 utilizes a cosine-similarity, or other loss function, in the teacher learning. Furthermore, in some embodiments, the multilingual vision language system 102 utilizes the output of the mean-squared-error loss function 350 to adjust the parameters of the multilingual large language model 114.

To illustrate, in some embodiments, the multilingual vision language system 102 compares the text embeddings for the text (e.g., in languages other than the first language) with the parallel text encodings of the parallel text (e.g., in the first language) to determine mean-squared-error losses. The multilingual vision language system 102 utilizes these mean-squared-error losses to tune the multilingual large language model 114 (e.g., in addition to the tuning based on the contrastive losses). Thus, in some embodiments, the multilingual vision language system 102 utilizes knowledge distillation to train the multilingual large language model 114, where the text encoder 120 with the first-language text (i.e., the parallel text) serve as a teacher model for the multilingual large language model 114.

Thus, the multilingual vision language system 102 utilizes cross-lingual teacher learning to further assist training the multilingual large language model 114 to embed multi-lingual text into the embedding space of a vision language model 116. Specifically, as described above, the multilingual vision language system 102 applies teacher learning between the text encoder 120 of the vision language model 116 (the teacher) and the multilingual large language model 114 (the student). Specifically, the multilingual vision language system 102 utilizes cross-lingual teacher learning to train the multilingual large language model 114 to generate matching embeddings to those of the text encoder 120 of the vision language model 116. For example, in one or more embodiments, the multilingual vision language system 102 utilizes a combined loss (a combination of the contrastive language image pretraining and cross-lingual teacher learning) to update or optimize the parameters of the multilingual large language model 114 to cause the multilingual large language model 114 to accurately embed multilingual text into the embedding space of the vision language model 116.

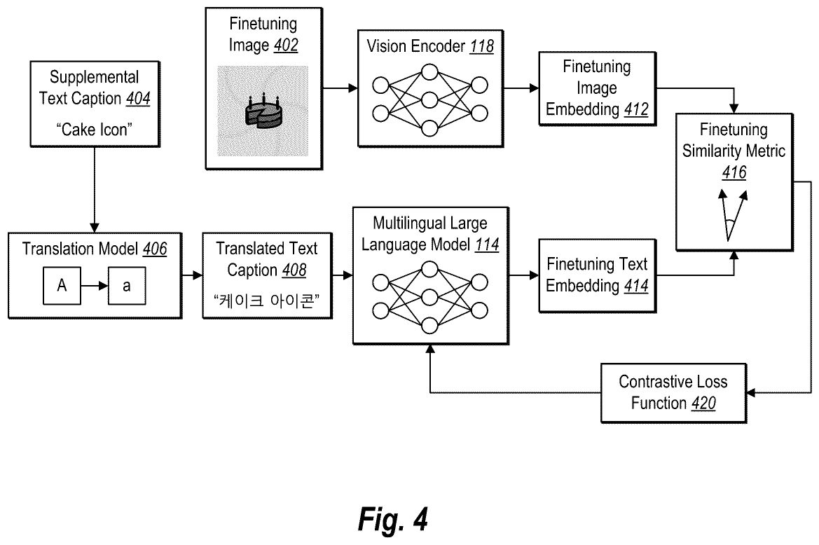

As mentioned, in some embodiments, the multilingual vision language system 102 finetunes the multilingual large language model 114 (e.g., after pretraining the multilingual large language model 114). For instance, FIG. 4 illustrates the multilingual vision language system 102 finetuning the multilingual large language model 114 in accordance with one or more embodiments.

Specifically, FIG. 4 shows a technique for translation-resampling by which the multilingual vision language system 102 finetunes the multilingual large language model 114. In some cases, training data is sparse for one or more languages, thus presenting an imbalance among different languages. For example, in some cases, the multilingual vision language system 102 has access to numerous training images and corresponding text in the first language (i.e., the language of the text encoder 120), many training images and corresponding text in a second language, and relatively few training images and corresponding text in a third language. In some embodiments, the multilingual vision language system 102 utilizes translation-resampling to rectify the sparsity of training data in the third language. For example, the multilingual vision language system 102 translates some of the first-language text into the third language and utilizes the translated text (and their corresponding training images) to augment the training of the multilingual large language model 114 with respect to the third language.

To illustrate, in some implementations, the multilingual vision language system 102 obtains a finetuning image 402 and a supplemental text caption 404 in the first language. The multilingual vision language system 102 utilizes a translation model 406 (e.g., machine translation) to generate a translated text caption 408 into the third language (e.g., one of the languages with sparse training data). The multilingual vision language system 102 processes the finetuning image 402 through the vision encoder 118 to generate a finetuning image embedding 412 (similar to the image embedding 212 described above). Additionally, the multilingual vision language system 102 processes the translated text caption 408 through the multilingual large language model 114 to generate a finetuning text embedding 414 (similar to the text embedding 214 described above).

Moreover, in some implementations, the multilingual vision language system 102 determines a finetuning similarity metric 416 between the finetuning image embedding 412 and the finetuning text embedding 414 (similar to the similarity metric 216 described above). The multilingual vision language system 102 processes the finetuning similarity metric 416 through a contrastive loss function 420 (similar to the contrastive loss function 220 described above) to tune the multilingual large language model 114. For example, the multilingual vision language system 102 adjusts parameters of the multilingual large language model 114 to reduce the output of the contrastive loss function (e.g., for a subsequent training iteration). In addition, in some embodiments, the multilingual vision language system 102 keeps the parameters of the vision encoder 118 fixed during training of the multilingual large language model 114.

Furthermore, as described above in connection with FIG. 2, in some implementations, the multilingual vision language system 102 determines finetuning pairings between the translated text and the finetuning images. For example, the multilingual vision language system 102 utilizes positive pairs (e.g., a first finetuning image and a first translated text caption of a first supplemental text caption corresponding to the first finetuning image) and negative pairs (e.g., the first finetuning image and a second translated text caption of a second supplemental text caption that does not correspond to the first finetuning image). As described above, the multilingual vision language system 102 utilizes the contrastive loss function 420 to train the multilingual large language model 114 to reduce distances between embeddings for positive pairs and increase distances between embeddings for negative pairs.

In some cases, by utilizing translation-resampling to finetune the multilingual large language model 114, the multilingual vision language system 102 improves image-text matching for the augmented language(s). For example, by augmenting the training data for the third language, the multilingual vision language system 102 enhances the accuracy determining matching images for text queries in the third language.

Moreover, in some cases, an imbalance in the training data among different languages affects the performance of image-text matching even for languages with a surplus of training data. To mitigate this, in some embodiments, the multilingual vision language system 102 augments (e.g., upsamples) the training data for one language and reduces (e.g., downsamples) the training data for another language. For example, in some cases, the training data includes a relatively small supply of images and corresponding text in a second language (e.g., Korean) and a relatively large supply of images and corresponding text in a third language (e.g., French). In some implementations, the multilingual vision language system 102 augments the batch of second-language text by translating a set of text in the first language (e.g., English) to generate translated text in the second language (e.g., Korean), and reduces the batch of third-language text by omitting a subset of the text in the third language (e.g., French) during training.

In this way, in some cases, the multilingual vision language system 102 enhances the image-text matching as to both the second language and the third language. For example, in some instances, by augmenting the second-language training data, the multilingual vision language system 102 boosts the ability of the multilingual large language model 114 to accurately embed text in the second language. In addition, in some instances, by reducing the third-language training data, the multilingual vision language system 102 boosts the performance of the multilingual large language model 114 as to the third language by preventing the multilingual large language model 114 from overfitting to the third language.

Moreover, in some embodiments, the multilingual vision language system 102 determines resampling ratios for the second language and the third language. For example, the multilingual vision language system 102 considers the relative amount of training data in the respective languages to determine how much to upsample and/or downsample the second and third languages. In some cases, the multilingual vision language system 102 determines language-specific resampling ratios with respect to the first language. In some cases, the multilingual vision language system 102 determines a relative resampling ratio for the second language with respect to the third language.

To illustrate, in at least one embodiment, the multilingual vision language system 102 determines a resampling ratio of 0.2 for French and a resampling ratio of 0.3 for Korean. In this case, the multilingual vision language system 102 augments (or reduces) the French training data to match the resampling ratio for French, and augments (or reduces) the Korean training data to match the resampling ratio for Korean. Moreover, in some embodiments, the multilingual vision language system 102 preserves a first-language sampling ratio (e.g., 0.5 for English) to retain capability of the multilingual large language model 114 to encode for the first language.

In some embodiments, the multilingual vision language system 102 determines an augmentation metric and/or a reduction metric for a language based on the resampling ratio. Thus, for example, in some embodiments, the multilingual vision language system 102 augments a batch of text in a second language based on the augmentation metric, and reduces a batch of text in a third language based on the reduction metric.

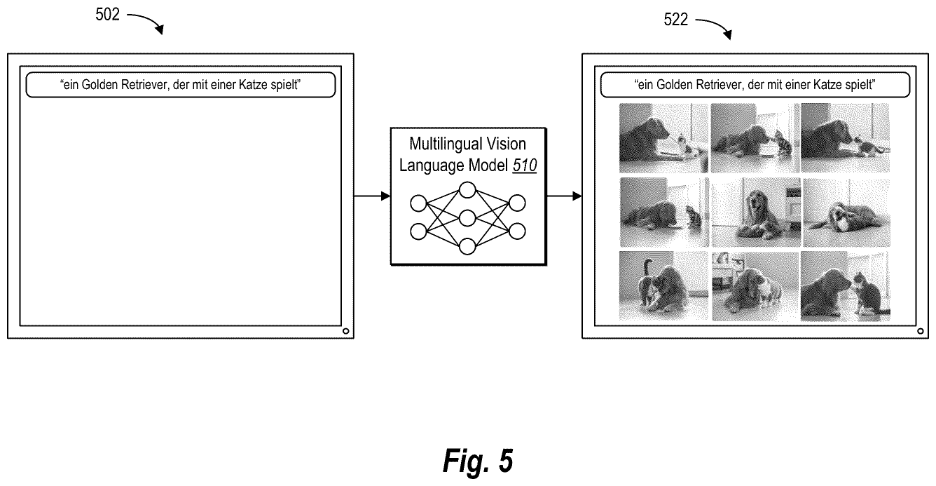

FIG. 5 shows an implementation of the multilingual vision language system 102. As mentioned, in some embodiments, the multilingual vision language system 102 combines a multilingual large language model with a vision encoder to create a multilingual vision language model. Moreover, in some embodiments, the multilingual vision language system 102 utilizes the multilingual vision language model to determine digital images that correspond to a query text. For instance, FIG. 5 illustrates the multilingual vision language system 102 processing a query text through a multilingual vision language model to determine corresponding digital images in accordance with one or more embodiments.

Specifically, FIG. 5 shows a user device with a graphical user interface 502 and a query text (e.g., “ein Golden Retriever, der mit einer Katze spielt” which is German for “a golden retriever playing with a cat”). In some cases, the multilingual vision language system 102 processes the query text through a multilingual vision language model 510 to determine one or more digital images corresponding to the query text (e.g., pictures of a golden retriever and a cat). Moreover, in some embodiments, the multilingual vision language system 102 provides the one or more digital images for display via a graphical user interface 522 of the user device.

As mentioned, in some embodiments, the multilingual vision language system 102 generates the multilingual vision language model 510 by combining the multilingual large language model 114 and the vision encoder 118. Furthermore, in some embodiments, the multilingual vision language system 102 utilizes the multilingual vision language model 510 to predict text-image pairs. Thus, the multilingual vision language system 102 determines digital images corresponding to query texts. As discussed, the multilingual vision language system 102 handles query texts in languages other than the language of the text encoder 120. For instance, in some instances, the multilingual vision language system 102 processes a query text in a language other than the first language through the multilingual vision language model 510 to determine one or more digital images corresponding to the query text.

As mentioned, in some embodiments, the multilingual vision language system 102 provides several technical improvements over existing vision language systems. For example, experiments were performed to compare the multilingual vision language system 102 with existing vision language systems. The table below shows results of the experiments across four languages (French, German, Japanese, and Korean), utilizing recall as the evaluation metric. As shown in the table, the multilingual vision language system 102 has improved recall over the existing systems for all four test languages.

| | French | German | Japanese | Korean |
|---|---|---|---|---|
| Multilingual Vision | 0.640 | 0.648 | 0.627 | 0.604 |
| Language System | | | | |
| Existing System 1 | 0.563 | 0.614 | 0.484 | 0.499 |
| Existing System 2 | 0.572 | 0.599 | 0.404 | 0.351 |

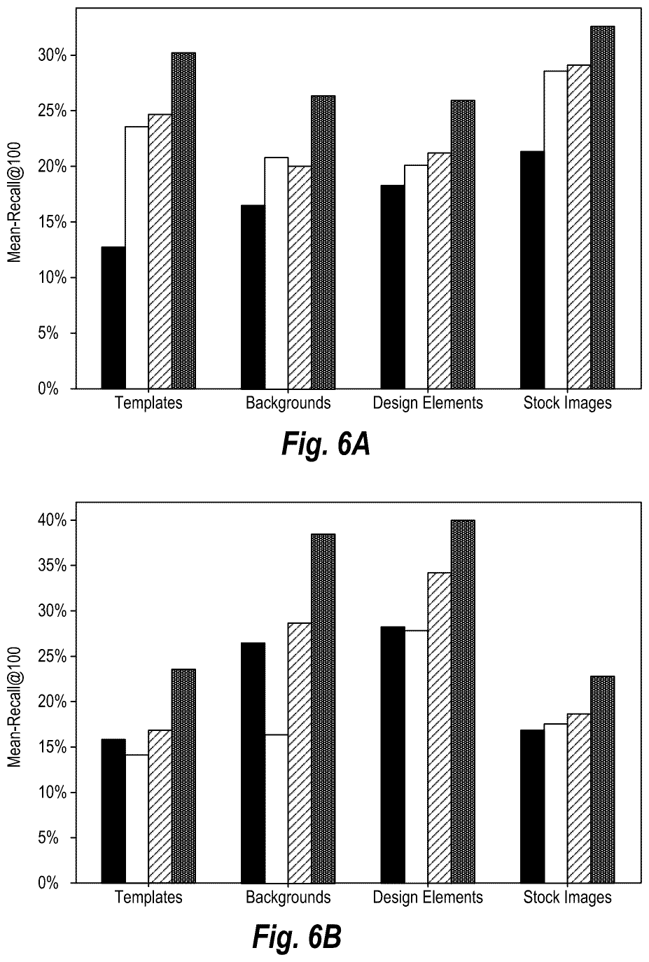

In addition to experiments comparing the multilingual vision language system 102 with existing systems, experiments for different embodiments of the multilingual vision language system 102 were conducted. FIGS. 6A and 6B illustrate recall results for two languages, respectively, across different types of image datasets and for four different embodiments of the multilingual vision language system 102. In particular, FIGS. 6A and 6B show results across template images, background images, design elements, and stock images. Template images include reference images for comparing or matching other images to detect similarities and/or differences. Design elements include components used for creating design images, such as lines, shapes, textures, patterns, and typography. Moreover, FIGS. 6A and 6B show results for a first embodiment of a pretrained (without finetuning) multilingual vision language system, a second embodiment of a pretrained (without finetuning) multilingual vision language system, a third embodiment of a finetuned multilingual vision language system, and a fourth embodiment of a finetuned multilingual vision language system.

As demonstrated by FIGS. 6A and 6B, finetuning (e.g., utilizing the translation-resampling techniques described above in connection with FIG. 4) further increases the recall of the multilingual vision language system 102, in nearly all image categories and for both test languages.

In addition to quantitative improvements over existing systems, the multilingual vision language system 102 demonstrates good qualitative performance. In particular, the multilingual vision language system 102 effectively aligns multilingual text descriptions with images, maintaining high content relevancy. For example, as shown in FIG. 5 the multilingual vision language system 102 outputs highly relevant images in response to a query text (e.g., by showing images of a golden retriever playing with a cat in response to a German query text asking for a golden retriever playing with a cat).

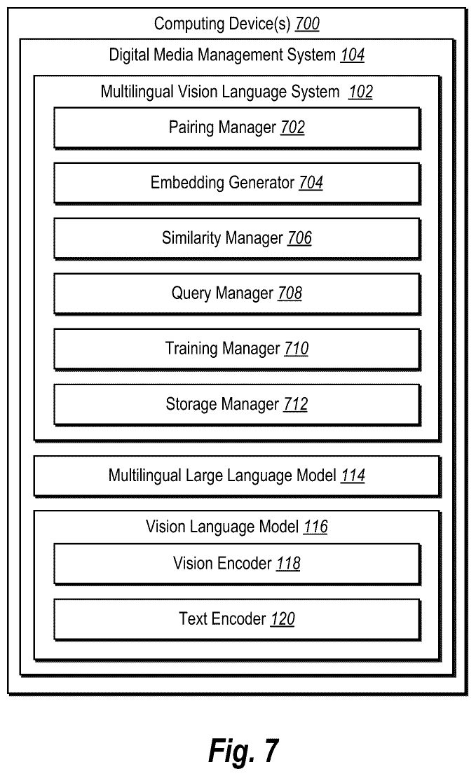

Turning now to FIG. 7, additional detail will be provided regarding components and capabilities of one or more embodiments of the multilingual vision language system 102. In particular, FIG. 7 illustrates an example multilingual vision language system 102 executed by a computing device(s) 700 (e.g., the server device(s) 106 or the client device 108). As shown by the embodiment of FIG. 7, the computing device(s) 700 includes or hosts the digital media management system 104 and/or the multilingual vision language system 102. Furthermore, as shown in FIG. 7, the multilingual vision language system 102 includes a pairing manager 702, an embedding generator 704, a similarity manager 706, a query manager 708, a training manager 710, and a storage manager 712.

As shown in FIG. 7, the multilingual vision language system 102 includes a pairing manager 702. In some implementations, the pairing manager 702 determines pairings of images and text (e.g., for training the multilingual large language model 114). For example, the pairing manager 702 determines a first pairing between a first image and a first text caption, and a second pairing between the first image and a second text caption.

In addition, as shown in FIG. 7, the multilingual vision language system 102 includes an embedding generator 704. In some implementations, the embedding generator 704 generates embeddings for images and/or text. For instance, the embedding generator 704 utilizes the vision encoder 118 to generate image embeddings for the images. Additionally, the embedding generator 704 utilizes the multilingual large language model 114 to generate text embeddings for the text.

Moreover, as shown in FIG. 7, the multilingual vision language system 102 includes a similarity manager 706. In some implementations, the similarity manager 706 determines similarity metrics between image embeddings and text embeddings. For example, in some embodiments, the similarity manager 706 determines a cosine similarity between a text embedding for a text caption and an image embedding for an image.

Furthermore, as shown in FIG. 7, the multilingual vision language system 102 includes a query manager 708. In some implementations, the query manager 708 receives and processes query texts. For instance, the query manager 708 processes a query text through the multilingual vision language model 510 to determine one or more digital images corresponding to the query text.

Additionally, as shown in FIG. 7, the multilingual vision language system 102 includes a training manager 710. In some implementations, the training manager 710 trains (e.g., modifies parameters of) one or more machine learning models, as described above, including the multilingual large language model 114. For example, the training manager 710 tunes parameters of the multilingual large language model 114 based on a measure of loss for a set of digital images and corresponding text. To illustrate, the training manager 710 utilizes a contrastive loss function and/or a mean-squared-error loss function to generate measures of loss to adjust the parameters of the multilingual large language model 114.

Additionally, as shown in FIG. 7, the multilingual vision language system 102 includes a storage manager 712. In some implementations, the storage manager 712 stores information (e.g., via one or more memory devices) on behalf of the multilingual vision language system 102. For example, the storage manager 712 stores training images, training text, parameters of the multilingual large language model 114, parameters of the vision language model 116, parameters of the multilingual vision language model 510, query texts, and/or image results for the query texts.

Each of the components 702-712 of the multilingual vision language system 102 includes software, hardware, or both. For example, the components 702-712 include one or more instructions stored on a computer-readable storage medium and executable by processors of one or more computing devices, such as a client device or server device. When executed by the one or more processors, in some implementations, the computer-executable instructions of the multilingual vision language system 102 cause the computing device(s) to perform the methods described herein. Alternatively, in one or more implementations, the components 702-712 include hardware, such as a special purpose processing device to perform a certain function or group of functions. Alternatively, in some implementations, the components 702-712 of the multilingual vision language system 102 include a combination of computer-executable instructions and hardware.

Furthermore, the components 702-712 of the multilingual vision language system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 702-712 are implemented as a stand-alone application, such as a desktop or mobile application. Furthermore, in various implementations, the components 702-712 are implemented as one or more web-based applications hosted on a remote server. In some implementations, the components 702-712 are implemented in a suite of mobile device applications or “apps.” To illustrate, in some implementations, the components 702-712 are implemented in an application, including but not limited to Adobe Creative Cloud, Adobe Express, and Adobe Photoshop. The foregoing are either registered trademarks or trademarks of Adobe in the United States and/or other countries.

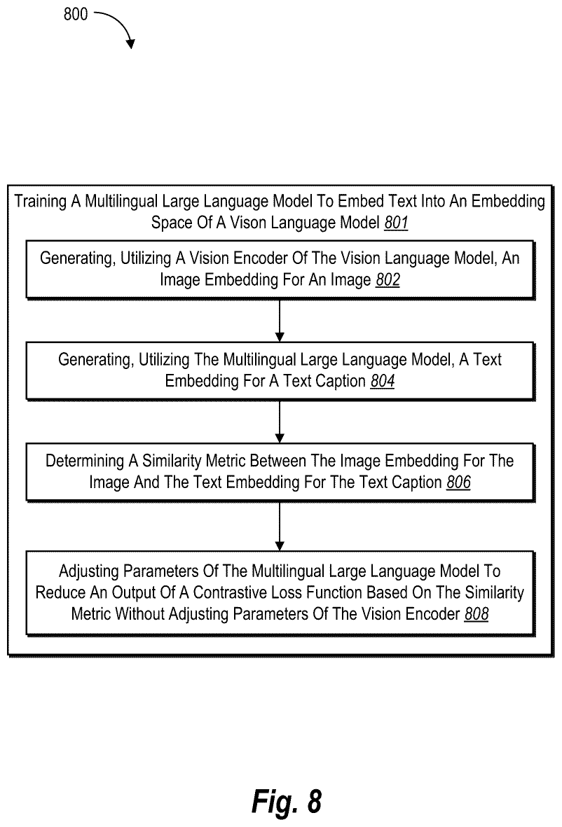

FIGS. 1-7, the corresponding text, and the examples provide a number of different methods, systems, devices, and non-transitory computer-readable media of the multilingual vision language system 102. In addition to the foregoing, one or more embodiments are described in terms of flowcharts comprising acts for accomplishing a particular result, as shown in FIG. 8. In some implementations, the processes of the multilingual vision language system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 8 illustrates a flowchart of a series of acts 800 for training a multilingual large language model to embed text into an embedding space of a vision language model in accordance with one or more implementations. While FIG. 8 illustrates acts according to one implementation, alternative implementations omit, add to, reorder, and/or modify any of the acts shown in FIG. 8. In one or more implementations, the acts of FIG. 8 are performed as part of a method (e.g., a computer-implemented method). Alternatively, in one or more implementations, a non-transitory computer-readable storage medium comprises instructions that, when executed by one or more processors, cause a computing device to perform the acts of FIG. 8. In some implementations, a system performs the acts of FIG. 8.

As shown in FIG. 8, the series of acts 800 includes an act 801 of training a multilingual large language model to embed text into an embedding space of a vision language model. Moreover, the act 801 includes various additional acts, including an act 802 of generating, utilizing a vision encoder of the vision language model, an image embedding for an image, an act 804 of generating, utilizing the multilingual large language model, a text embedding for a text caption, an act 806 of determining a similarity metric between the image embedding for the image and the text embedding for the text caption, and an act 808 of adjusting parameters of the multilingual large language model to reduce an output of a contrastive loss function based on the similarity metric without adjusting parameters of the vision encoder.

In particular, in some implementations, the act 801 includes training a multilingual large language model to embed text into an embedding space of a vision language model. The vision language model comprises a text encoder for a first language and a vision encoder. The act 802 includes generating, utilizing the vision encoder, image embeddings for the images. The act 804 includes generating, utilizing the multilingual large language model, text embeddings for the text. The act 806 includes determining similarity metrics between the image embeddings for the images and the text embeddings for the text. The act 808 includes adjusting parameters of the multilingual large language model to reduce an output of a contrastive loss function based on the similarity metrics without adjusting parameters of the vision encoder. Additionally, in some implementations, the series of acts includes determining pairings between images and text corresponding to the images, the text being in languages other than the first language.

Moreover, in some implementations, the series of acts 800 includes determining a pairing between an image and a text caption corresponding to the image. The series of acts 800 includes generating, utilizing the vision encoder, an image embedding for the image. Additionally, the series of acts 800 includes generating, utilizing the multilingual large language model, a text embedding for the text caption. The series of acts 800 includes determining a similarity metric between the image embedding for the image and the text embedding for the text caption and adjusting parameters of the multilingual large language model to reduce an output of a contrastive loss function based on the similarity metric without adjusting parameters of the vision encoder. Additionally, in one or more embodiments, the series of acts 800 includes processing a query text in a language other than the first language through a combined model comprising the multilingual large language model and the vision encoder of the vision language model to determine one or more digital images corresponding to the query text.

Furthermore, in some implementations, the series of acts 800 includes combining the multilingual large language model with the vision encoder of the vision language model to create a multilingual vision language model for predicting text-image pairs. Additionally, in some implementations, the series of acts 800 includes processing a query text, in a language other than the first language, through the multilingual vision language model to determine one or more digital images corresponding to the query text. In addition, in some implementations, the series of acts 800 includes combining the multilingual large language model with the vision encoder of the vision language model to create a multilingual vision language model for predicting text-image pairs; and processing a query text, in a language other than the first language, through the multilingual vision language model to determine one or more digital images corresponding to the query text.

Moreover, in some implementations, the series of acts 800 includes determining the pairings between the images and the text by determining a first pairing between a first image and a first text caption. In some implementations, the series of acts 800 includes determining a second pairing between the first image and a second text caption. The series of acts 800 includes, in one or more embodiments, determining the similarity metrics between the image embeddings and the text embeddings by determining a first similarity metric for the first pairing and determining a second similarity metric for the second pairing. The series of acts 800 includes in some implementations, adjusting the parameters of the multilingual large language model by adjusting the parameters of the multilingual large language model to increase the first similarity metric and to reduce the second similarity metric.

Furthermore, in some implementations, the series of acts 800 includes determining an additional pairing between the image and an additional text caption; determining an additional similarity metric between the image embedding for the image and an additional text embedding for the additional text caption; and adjusting the parameters of the multilingual large language model to further reduce the output of the contrastive loss function to increase the similarity metric and to reduce the additional similarity metric.

Additionally, in some implementations, the series of acts 800 includes determining the pairings between the images and the text by: determining a first pairing between a first image and a first text caption; and determining a second pairing between the first image and a second text caption; determining the similarity metrics between the image embeddings and the text embeddings by: determining a first similarity metric for the first pairing; and determining a second similarity metric for the second pairing; and adjusting the parameters of the multilingual large language model by: adjusting the parameters of the multilingual large language model to increase the first similarity metric for a subsequent training iteration for the multilingual large language model and to reduce the second similarity metric for the subsequent training iteration for the multilingual large language model.

Moreover, in some implementations, the series of acts 800 includes finetuning the multilingual large language model by: generating translated text in a second language from supplemental text in the first language; determining finetuning pairings between the translated text in the second language and finetuning images corresponding to the supplemental text in the first language; determining finetuning similarity metrics between finetuning image embeddings for the finetuning images and finetuning text embeddings for the translated text; and adjusting the parameters of the multilingual large language model to further reduce the output of the contrastive loss function based on the finetuning similarity metrics without adjusting the parameters of the vision encoder.

Furthermore, in some implementations, the series of acts 800 includes generating a translated text caption in a second language from a supplemental text caption in the first language; determining a finetuning pairing between the translated text caption in the second language and a finetuning image corresponding to the supplemental text caption in the first language; determining a finetuning similarity metric between a finetuning image embedding for the finetuning image and a finetuning text embedding for the translated text caption; and adjusting the parameters of the multilingual large language model to further reduce the output of the contrastive loss function based on the finetuning similarity metric without adjusting the parameters of the vision encoder.

In addition, in some implementations, the series of acts 800 includes finetuning the multilingual large language model by: generating translated text in at least one of the languages other than the first language by translating supplemental text from the first language to the at least one of the languages other than the first language; determining finetuning pairings between the translated text and finetuning images corresponding to the supplemental text in the first language; determining finetuning similarity metrics between finetuning image embeddings for the finetuning images and finetuning text embeddings for the translated text; and adjusting the parameters of the multilingual large language model to further reduce the output of the contrastive loss function based on the finetuning similarity metrics without adjusting the parameters of the vision encoder.

Moreover, in some implementations, the series of acts 800 includes adjusting, utilizing knowledge distillation from the text encoder of the vision language model, the parameters of the multilingual large language model to reduce an output of a mean-squared-error loss function based on the text embeddings for the text and parallel text encodings of parallel text generated by the text encoder of the vision language model. Furthermore, in some implementations, the series of acts 800 includes distilling knowledge from the text encoder of the vision language model by: adjusting the parameters of the multilingual large language model to reduce an output of a mean-squared-error loss function based on the text embedding for the text caption and a parallel text encoding of a parallel text caption generated by the text encoder of the vision language model. Additionally, in some implementations, the series of acts 800 includes adjusting the parameters of the multilingual large language model to reduce an output of a mean-squared-error loss function based on the text embeddings for the text and parallel text encodings of parallel text generated by the text encoder of the vision language model.

Moreover, in some implementations, the series of acts 800 includes augmenting a second-language batch of text in a second language by translating a set of text in the first language to generate translated text in the second language; and reducing a third-language batch of text in a third language by omitting a subset of text of the third-language batch of text. Furthermore, in some implementations, the series of acts 800 includes augmenting a second-language batch of text in a second language by translating a set of text in the first language to generate translated text in the second language; and reducing a third-language batch of text in a third language by omitting a subset of text of the third-language batch of text.

In addition, in some implementations, the series of acts 800 includes augmenting a second-language batch of text in a second language by translating a set of text in the first language to generate translated text in the second language for the pairings between the images and the text; and reducing a third-language batch of text in a third language by omitting a subset of text of the third-language batch of text from the pairings between the images and the text.

Moreover, in some implementations, the series of acts 800 includes determining a resampling ratio for the second language and the third language; determining an augmentation metric based on the resampling ratio and a reduction metric based on the resampling ratio; augmenting the second-language batch of text based on the augmentation metric; and reducing the third-language batch of text based on the reduction metric. Furthermore, in some implementations, the series of acts 800 includes determining an augmentation metric for the second language and a reduction metric for the third language; augmenting the second-language batch of text based on the augmentation metric; and reducing the third-language batch of text based on the reduction metric.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 9 illustrates a block diagram of an example computing device 900 that may be configured to perform one or more of the processes described above. One will appreciate that one or more computing devices, such as the computing device 900, may represent the computing devices described above (e.g., the computing device(s) 700, the server device(s) 106, or the client device 108). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes the memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes the storage device 906 for storing data or instructions. As an example, and not by way of limitation, the storage device 906 can include a non-transitory storage medium described above. The storage device 906 may include a hard disk drive (“HDD”), flash memory, a Universal Serial Bus (“USB”) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include the bus 912. The bus 912 can include hardware, software, or both that connects components of computing device 900 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
training a multilingual large language model to embed text into an embedding space of a vision language model, the vision language model comprising a text encoder for a first language and a vision encoder, by:
determining pairings between images and text corresponding to the images, the text being in languages other than the first language;
generating, utilizing the vision encoder, image embeddings for the images;
generating, utilizing the multilingual large language model, text embeddings for the text;
determining similarity metrics between the image embeddings for the images and the text embeddings for the text; and
adjusting parameters of the multilingual large language model to reduce an output of a contrastive loss function based on the similarity metrics without adjusting parameters of the vision encoder.

2. The computer-implemented method of claim 1, further comprising combining the multilingual large language model with the vision encoder of the vision language model to create a multilingual vision language model for predicting text-image pairs.

3. The computer-implemented method of claim 2, further comprising processing a query text, in a language other than the first language, through the multilingual vision language model to determine one or more digital images corresponding to the query text.

4. The computer-implemented method of claim 1, wherein:
determining the pairings between the images and the text comprises:
determining a first pairing between a first image and a first text caption; and
determining a second pairing between the first image and a second text caption;
determining the similarity metrics between the image embeddings and the text embeddings comprises:
determining a first similarity metric for the first pairing; and
determining a second similarity metric for the second pairing; and
adjusting the parameters of the multilingual large language model comprises:
adjusting the parameters of the multilingual large language model to increase the first similarity metric and to reduce the second similarity metric.

5. The computer-implemented method of claim 1, further comprising:
finetuning the multilingual large language model by:
generating translated text in a second language from supplemental text in the first language;
determining finetuning pairings between the translated text in the second language and finetuning images corresponding to the supplemental text in the first language;
determining finetuning similarity metrics between finetuning image embeddings for the finetuning images and finetuning text embeddings for the translated text; and
adjusting the parameters of the multilingual large language model to reduce the output of the contrastive loss function based on the finetuning similarity metrics without adjusting the parameters of the vision encoder.

6. The computer-implemented method of claim 1, further comprising:
adjusting, utilizing knowledge distillation from the text encoder of the vision language model, the parameters of the multilingual large language model to reduce an output of a mean-squared-error loss function based on the text embeddings for the text and parallel text encodings of parallel text generated by the text encoder of the vision language model.

7. The computer-implemented method of claim 1, further comprising:
augmenting a second-language batch of text in a second language by translating a set of text in the first language to generate translated text in the second language; and
reducing a third-language batch of text in a third language by omitting a subset of text of the third-language batch of text.

8. A system comprising:
one or more memory devices comprising a multilingual large language model and a vision language model comprising a text encoder for a first language and a vision encoder; and
one or more processors configured to cause the system to:
determine a pairing between an image and a text caption corresponding to the image;
generate, utilizing the vision encoder, an image embedding for the image;
generate, utilizing the multilingual large language model, a text embedding for the text caption;
determine a similarity metric between the image embedding for the image and the text embedding for the text caption;
adjust parameters of the multilingual large language model to reduce an output of a contrastive loss function based on the similarity metric without adjusting parameters of the vision encoder; and
process a query text in a language other than the first language through a combined model comprising the multilingual large language model and the vision encoder of the vision language model to determine one or more digital images corresponding to the query text.

9. The system of claim 8, wherein the one or more processors are further configured to cause the system to:
determine an additional pairing between the image and an additional text caption;
determine an additional similarity metric between the image embedding for the image and an additional text embedding for the additional text caption; and
adjust the parameters of the multilingual large language model to further reduce the output of the contrastive loss function to increase the similarity metric and to reduce the additional similarity metric.

10. The system of claim 8, wherein the one or more processors are further configured to cause the system to:
generate a translated text caption in a second language from a supplemental text caption in the first language;
determine a finetuning pairing between the translated text caption in the second language and a finetuning image corresponding to the supplemental text caption in the first language;
determine a finetuning similarity metric between a finetuning image embedding for the finetuning image and a finetuning text embedding for the translated text caption; and
adjust the parameters of the multilingual large language model to further reduce the output of the contrastive loss function based on the finetuning similarity metric without adjusting the parameters of the vision encoder.

11. The system of claim 8, wherein the one or more processors are further configured to cause the system to distill knowledge from the text encoder of the vision language model by:
adjusting the parameters of the multilingual large language model to reduce an output of a mean-squared-error loss function based on the text embedding for the text caption and a parallel text encoding of a parallel text caption generated by the text encoder of the vision language model.

12. The system of claim 8, wherein the one or more processors are further configured to cause the system to:
augment a second-language batch of text in a second language by translating a set of text in the first language to generate translated text in the second language; and
reduce a third-language batch of text in a third language by omitting a subset of text of the third-language batch of text.

13. The system of claim 12, wherein the one or more processors are further configured to cause the system to:
determine a resampling ratio for the second language and the third language;
determine an augmentation metric based on the resampling ratio and a reduction metric based on the resampling ratio;
augment the second-language batch of text based on the augmentation metric; and
reduce the third-language batch of text based on the reduction metric.

14. A non-transitory computer-readable medium storing executable instructions that, when executed by a processing device, cause the processing device to perform operations comprising:
training a multilingual large language model to embed text into an embedding space of a vision language model, the vision language model comprising a text encoder for a first language and a vision encoder, by:
determining pairings between images and text corresponding to the images, the text being in languages other than the first language;
generating, utilizing the vision encoder, image embeddings for the images;
generating, utilizing the multilingual large language model, text embeddings for the text;
determining similarity metrics between the image embeddings for the images and the text embeddings for the text; and
adjusting parameters of the multilingual large language model to reduce an output of a contrastive loss function based on the similarity metrics without adjusting parameters of the vision encoder.

15. The non-transitory computer-readable medium of claim 14, wherein the operations further comprise:
combining the multilingual large language model with the vision encoder of the vision language model to create a multilingual vision language model for predicting text-image pairs; and
processing a query text, in a language other than the first language, through the multilingual vision language model to determine one or more digital images corresponding to the query text.

16. The non-transitory computer-readable medium of claim 14, wherein:
determining the pairings between the images and the text comprises:
determining a first pairing between a first image and a first text caption; and
determining a second pairing between the first image and a second text caption;
determining the similarity metrics between the image embeddings and the text embeddings comprises:
determining a first similarity metric for the first pairing; and
determining a second similarity metric for the second pairing; and
adjusting the parameters of the multilingual large language model comprises:
adjusting the parameters of the multilingual large language model to increase the first similarity metric for a subsequent training iteration for the multilingual large language model and to reduce the second similarity metric for the subsequent training iteration for the multilingual large language model.

17. The non-transitory computer-readable medium of claim 14, wherein the operations further comprise:
finetuning the multilingual large language model by:
generating translated text in at least one of the languages other than the first language by translating supplemental text from the first language to the at least one of the languages other than the first language;
determining finetuning pairings between the translated text and finetuning images corresponding to the supplemental text in the first language;
determining finetuning similarity metrics between finetuning image embeddings for the finetuning images and finetuning text embeddings for the translated text; and
adjusting the parameters of the multilingual large language model to reduce the output of the contrastive loss function based on the finetuning similarity metrics without adjusting the parameters of the vision encoder.

18. The non-transitory computer-readable medium of claim 14, wherein the operations further comprise:
adjusting the parameters of the multilingual large language model to reduce an output of a mean-squared-error loss function based on the text embeddings for the text and parallel text encodings of parallel text generated by the text encoder of the vision language model.

19. The non-transitory computer-readable medium of claim 14, wherein the operations further comprise:
augmenting a second-language batch of text in a second language by translating a set of text in the first language to generate translated text in the second language for the pairings between the images and the text; and
reducing a third-language batch of text in a third language by omitting a subset of text of the third-language batch of text from the pairings between the images and the text.

20. The non-transitory computer-readable medium of claim 19, wherein the operations further comprise:
determining an augmentation metric for the second language and a reduction metric for the third language;
augmenting the second-language batch of text based on the augmentation metric; and
reducing the third-language batch of text based on the reduction metric.
